(19) United States
(12) Patent Application Publication
(10) Pub. No.: US 2009/0022148 A1
(43) Pub. Date: Jan. 22, 2009

(54) VOICE OVER INTERNET PROTOCOL SYSTEM AND METHOD FOR PROCESSING OF TELEPHONIC VOICE OVER A DATA NETWORK

(76) Inventor: Joseph C. Anders, Mobile, AL (US)

Correspondence Address: BUSH INTELLECTUAL PROPERTY LAW GROUP, LLC, P.O. BOX 381146, BIRMINGHAM, AL, 35238, US

(21) Appl. No.: 11/912,378

(22) PCT Filed: Apr. 26, 2006
(86) PCT No.: PCT/US2006/015618

§ 371 Date: Aug. 14, 2008

Related U.S. Application Data
(60) Provisional application No. 60/674,995, filed on Apr. 26, 2005.

(51) Int. Cl. H04L 12/66

(52) U.S. Cl. 370/356

(57) ABSTRACT

A method and system for processing of telephonic voice over a data network, such as the Internet, which includes a signaling protocol with little overhead and allows for dynamic connections to a host. The system uses a signaling protocol which creates an ad hoc connection to the host which reduces the per packet information necessary to conduct the communication. The system provides for quick and efficient establishment of communications from multiple remote locations to a central host. Each remote location may only connect to the host or a redundant host.

### TECHNICAL FIELD

The present invention relates generally to the field of communications and, more specifically, to a system and method for transferring telephonic voice over packet switched networks, such as Internet protocol (IP) networks.

### BACKGROUND ART

T-1 (DS1) trunks are circuit switched data networks supporting data rates of 1.544 Mbits per second. A T-1 trunk can carry 24 individual 64 Kbits per second channels, each of which may carry data or telephony quality voice. Similarly, E1 trunks are circuit switched data networks supporting data rates of 2.048 Mbps (32 channels at 64 Kbps). T-3 and E3 trunks support data rates of 44,736 and 34,368 Kbps, respectively. Together T1, E1, T3, E3 and similar circuit switched serial networks are known as Time Division Multiplexing (TDM) networks.

TDM is a type of multiplexing that combines data streams by assigning each stream a different time slot in a set. TDM repeatedly transmits a fixed sequence of time slots over a single transmission channel. Within T-Carrier (T-C) systems, such as T-1 and T-3 (DS3), TDM combines Pulse Code Modulated (PCM) streams created for each T-C carrier system in conversation or data stream.

High-speed IP-based networks are the latest innovation in the world of communications. The capacity of these networks is increasing at a prodigious rate, fueled by the popularity of the Internet and decreasing costs associated with the technology. Worldwide data traffic volume has already surpassed that of the telephone network, and for many applications, the pricing of IP traffic has dropped below the tariffs associated with traditional TDM service. For this reason, significant effort is being expended on Voice over Internet Protocol (VoIP) technologies. For users who have free, or fixed-price Internet access, Internet telephony software essentially provides free telephone calls anywhere in the world. To date, however, Internet telephony does not offer the same quality of telephone service as direct telephone connections. There are many Internet telephony applications available. Some come bundled with popular Web browsers; others are stand-alone products. Internet telephony products are sometimes called IP telephony, Voice over the Internet (VoI) or VoIP products.

Inherent in all forms of VoIP is revolutionary change, whereby much of the existing telephony infrastructure will be replaced by novel IP-based mechanisms. Despite the expectations, this effort has been more protracted and less successful than initially expected. Today's telephony technology, both those portions that VoIP aims to replace and those to which VoIP must interface, is extremely complex. Revolutionary implementations of its hundreds of features and thousands of variations most likely cannot be developed in a short time frame.

The present communications revolution has been focused on the Internet and the Internet protocol (IP), providing the same switching capabilities from each end point as the Public Switched Telephone Network (PSTN). It would be advantageous to be able to use IP networks. The existing telephony infrastructure has an extremely high reliability (99.999%), supports reasonable audio quality (Mean Opinion Score, or MOS, 4.0 on a scale of 1 to 5), has almost universal market penetration, and offers a rich feature set. Accordingly, extremely potent incentives are required before one could reasonably consider supplanting existing telephony networks with IP networks. There are two such incentives, one economic and one technological.

The economic advantage of IP networks is shared by all packet networks; namely, that multiple packetized data streams can share a circuit, while a TDM timeslot occupies a dedicated circuit for the call's duration. Under “polite conversation” assumption of each party speaking only half of the time, and the “optimal engineering” assumption of minimal overhead, packet networks will, on average, double the bandwidth efficiency, thus halving operational costs. Taking overhead and peak statistics into account, the savings will be somewhat less, but a 30% reduction is attainable. However, this savings alone might not be a strong enough incentive to make the switch from TDM to IP.

The added technological incentive has to do with the raw rates for data traffic as compared to voice traffic. At present, data communications are metered separately from traditional voice communications and are offered at substantial savings. These savings are partly due to tariffs and access charges that increase the cost of traditional voice services, and partly due to the attractive pricing of IP traffic. Voice service pricing is still mostly determined by incumbent carriers with high overhead costs, while IP traffic costs are much more competitive, as the provider incurs lower costs and is more focused on increasing market share. The technological incentive can be referred to as convergence because technological simplification and synergy will result from consolidation of the various sources into an integrated environment. For example, with a single residential information source provisioned for telephony, IP data and entertainment programming would in principle decrease end user prices, result in a single unified billing package, and eventually enable advanced services, such as video-on-demand.

### The Limitations of VoIP

In principle, it would not seem difficult to carry voice over IP networks. A digitized voice signal is simply data and can be carried by a packet network just like any other data. The major technological achievement of the telephone network, least cost routing, has its counterpart in IP networks as well. There are, however, fundamental problems with Quality of Service (QoS) and signaling that have to be solved before VoIP can be realistically considered to compete with TDM networks.

### Quality of Service

The meaning of Quality of Service for data is completely different than for voice. Although most data can withstand relatively significant delay, low delay and proper time ordering of the signal are critical for voice applications, even though loss of a few milliseconds of signal is usually not noticeable. These requirements are completely at odds with the basic principles of IP networks (although not necessarily with those of other packet networks). To overcome these constraints, mechanisms such as tunneling and jitter buffers need to be employed. Additional components of voice quality such as echo cancellation and voice compression are not inherent in data-based networks at all, and need to be added ad hoc for VoIP.

Almost all of the research and development effort in the field of VoIP is directed towards solving these QoS problems, leaving the signaling problem largely unsolved Signaling is the exchange of information needed for a telephone call other than the speech itself. Signaling consists of basic features such as determining whether the phone is off-hook or needs to ring; more advanced properties required for reaching the proper destination and billing; and still more sophisticated characteristics, such as caller identification, call forwarding, and conference calls; as well as more recent additions necessitated by intelligent networking. There are literally thousands of such telephony features, with dozens of national and local variations. Phone customers are mostly unaware of this complexity, at least until they are deprived of any of the features to which they have become accustomed.

Adding auxiliary information to digital voice on an IP network is in principle much simpler than signaling in telephone networks. One needn't “rob bits” or dedicate CAS channels. One need only send the signaling data in some appropriate format along with the voice. Indeed, the advantage of VoIP is that it becomes possible to add features that could not exist in the classic telephony world, for example video and “whiteboards.” This is true as long as the two sides to the conversation are using special VoIP terminals or computers. The problems arise when one must interface between the IP network and the standard telephony network, a connection that is imperative in light of the universal availability of standard telephone sets.

VoIP developers have envisioned conversations between two PC users or a PC user conversing with a telephone user. What may be more useful are conversations between two telephone users, each connected via a standard Local Loop to a central office, but with an IP-based network replacing the TDM network between the central offices. However, to properly pass the requisite signaling, the IP network would need to be enhanced to handle all the thousands of features and their variations (for example, 911 and *67 service), which VoIP developers have not yet accomplished.

Methods are known for communications using differing protocols, such as asynchronous transfer mode (ATM) over IP, across various communication standards. U.S. Pat. No. 5,623,605 (Methods and Systems for Interprocess Communication and Inter-Network Data Transfer) discloses the transmission of data packets between source and destination devices wherein generated and received data are in ATM-formatted frames and the network transmits data in Internet protocol packets. Such data transfer is accomplished using encapsulators and decapsulators to encapsulate ATM formatted frames in data portions of IP packets for transmission on the network. U.S. Pat. No. 5,946,313 (Mechanism for Multiplexing ATM AAL5 Virtual Circuits over Ethernet) describes a method for encapsulating/segmenting ATM cells over Ethernet. U.S. Pat. No. 5,548,646 (System for Signatureless Transmission and Reception of Data Packets Between Computer Networks) discloses a system for automatically encrypting (by adding an IP header) and decrypting a data packet sent from a source host to a destination host across a network. U.S. Pat. No. 5,936,965 (Method and Apparatus for Transmission of Asynchronous, Synchronous, and Variable Length Mode Protocols Multiplexed over a Common Bytestream) describes a system for supporting the transmission and reception of ATM over a common bytestream with a common physical layer datalink.

The following US patents provide a general teaching of IP over ATM: U.S. Pat. Nos. 5,715,250 (ATM-LAN connection apparatus of a small scale capable of connecting terminals of different protocol standards and ATM-LAN including the ATM-LAN connection apparatus); 5,903,559 (Method for Internet protocol switching over fast ATM cell transport); and 5,936,936 (Redundancy mechanisms for classical Internet protocol over asynchronous transfer mode networks) provide a general teaching of IP over ATM.

U.S. Pat. No. 6,731,649 (TDM over IP (IP circuit emulation service)) offers a solution for transferring transparently E1 or T1 (or fractional E1/T1) TDM services over widely deployed high speed IP networks. This technology can be used as a migration path to Voice over IP or a complementary solution to VoIP in places where voice over IP solution is not suitable. The same TDM over IP approach can be adopted to transfer other TDM rates (e.g., E3/T3, STM1 etc.) over the IP network.

### DISCLOSURE OF THE INVENTION

The present invention is a computer based communications system implementing voice over an Internet Protocol with an extremely efficient and low overhead signaling process. The system includes an IP network; a TDM source stream having an E1/T1 TDM stream which may originate at either the receiving station or the sending station; a decoder to decode the TDM source stream; a converter to convert and strip call progress tones into a separate data form; an encrypter/decrypter to encrypt the voice packets; a compressor to compress the remaining voice, where the silence suppression can be performed prior to the compression of the voice stream; a packetizer where the packets are output that are in an IP compatible format suitable for transfer over the IP Network, and the packetizer can packet the cells into UDP over IP frames; and a receiving section acquiring packets output from the packetizer and transferring them across the IP network. The receiving section comprises a cell extractor to strip the cells from the UDP payload; a reassembler to restructure the stripped cells into their correct sequence; a decompressor to decompress the compressed voice to PCM; a tone generator that allows the re-insertion of call progress tones into the decompressed voice; and a framer and encoder, where output from the framer and encoder is transmitted as a H.110 PCM voice. The entire out of band signaling is comprised of only seven commands and a command length is less than ten (5) bytes.

The present invention is a system wherein telephonic voice can be converted to data and transmitted over data circuitry with very low overhead for call signaling, transport and setup. The current invention departs from the classic inter-connectivity of every switch independently in favor of a strong centralized management method. All system intelligence is controlled at the central hosting locations with the “gateways” or “endpoints” being basically dumb devices. All switching and conversations between any location and another locations is handled in the central hosting locations. By using a very efficient packeting model and very small sideband signaling protocol, the true efficiencies of VoIP can be accomplished. The system creates a packet every 30 ms. In collecting the payload for the packet the algorithm picks up data from each of the 24 memory address that correspond to the 24 T-1 channels (23 in the case of PRI). If there is no data in the memory of a channel, an indicator of silence is used. A mask is placed at the beginning of the payload that identifies the calls (channels) with active payload content. This method greatly increases the efficiency of the packets used in transport. There only needs to be one set of header per packet and the packet can handle all twenty-four (24) possible calls at the same time. This removes the packet bloat that occurs in normal VoIP applications where each voice payload must have its own IP header overhead. Additionally, the efficiencies of this method allow for the encryption of the voice steam. The traditional VoIP methods have a difficult time tolerating the additional latency incurred by an encryption/decryption process. Leaving the calls un-encrypted exposes the voice traffic to interception.

With this method and system the existing PBX and phones are left in place. As the caller picks up the telephone receiver, the PBX performs its normal functions. If the call is not local, the PBX places the call out a T 1 connection to the Targeted Access Device. The Targeted Access Device compresses the entire bandwidth and establishes a connection to a port on a redundant centralized system. The central system interprets the most effective central system to handle the call based on the dialed digits. The data is passed to the appropriate central system where the data is processed by DSP's and the call is directed to its destination. If it is within the system, the call is simply conferenced to another stream that is sent to the Targeted Access Device located at the remote office. The Targeted Access Device at the remote location decrypts and decompresses the call presenting it to the remote PBX as a TDM call. If it is outside the system, the call is handed to the long distance carrier through a direct digital connection (DS3). Since have all the intelligence and signaling of the system has been centralized, it is only necessary that the voice bandwidth be compressed. This allows the system to be much more efficient in bandwidth consumption. The system only requires 8 Kilo bits per second including all signaling and overhead.

The key to this efficiency is in the simplicity of the device used at the site. The device simply compresses the voice bandwidth and establishes a direct connection to any port on the host system. It provides phone identifying information when establishing the session. No other processing is taking place at the site. The interface to the PBX is a standard T 1 interface.

The Data Center is the location where all the logic and processing takes place and where all billing is calculated and stored. The servers running in this data center are redundant and each port is only occupied for the duration of a single call. Therefore, the central data center only needs to have available ports for the number of calls during any peak period. This improves efficiency and reduces costs compared to existing systems.

An additional feature is that every call is encrypted with a unique encryption key for each call. This method prevents the leak of an encryption key from compromising the security of the system. All signaling is also encrypted using different keys on each call setup.

### BRIEF DESCRIPTION OF THE DRAWINGS

FIG. 1 illustrates the system of the present invention, with the TAD (target access device) located at each remote location.

FIG. 2 depicts the data flow processes necessary for the placement of a call out from the local PBX.

FIG. 3 depicts the data flow processes necessary for the receipt of a call as it is processed to the local PBX.

FIG. 4 illustrates the logic in the call process.

### BEST MODES FOR CARRYING OUT THE INVENTION

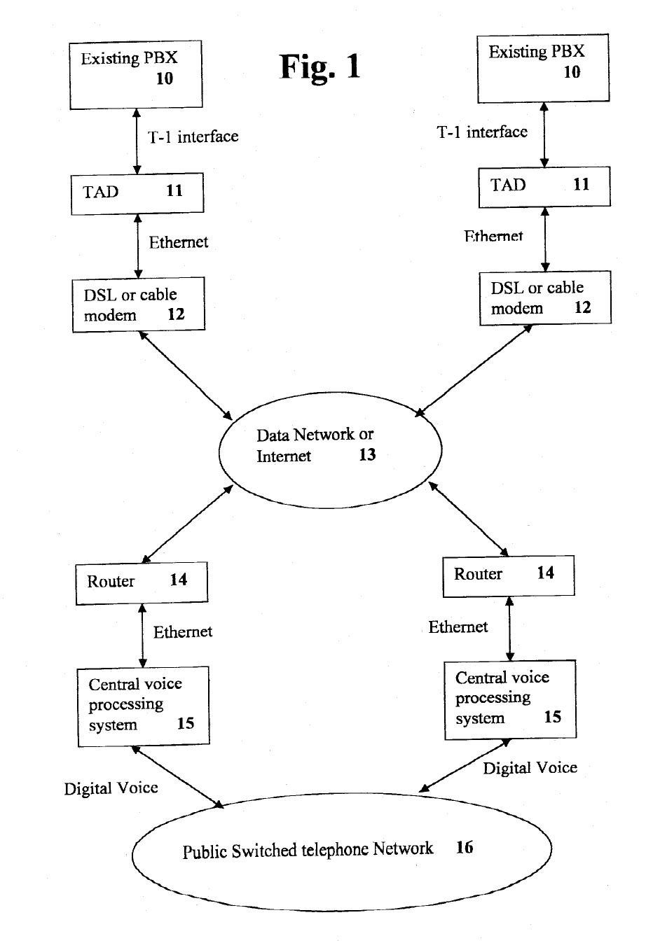

FIG. 1 illustrates the system of the present invention, with the TAD (targeted access device) located at each remote location. One or more existing PBX 10 (private branch exchange) are connected to a TAD device 11 by means of a T-1 interface. The TAD device 11 is connected to a DSL or cable modem 12 through an ethernet system. The DSL or cable modem 12 is connected to a communication system 13, such as, for example, a data network or the Internet. A public switched telephone network (PSTN) 16 communicates digital voice signals to one or more central voice processing systems 15. The central voice processing system 15 transmits voice signals to router 14 over an ethernet system, and the router 14 interfaces with the communication system 13.

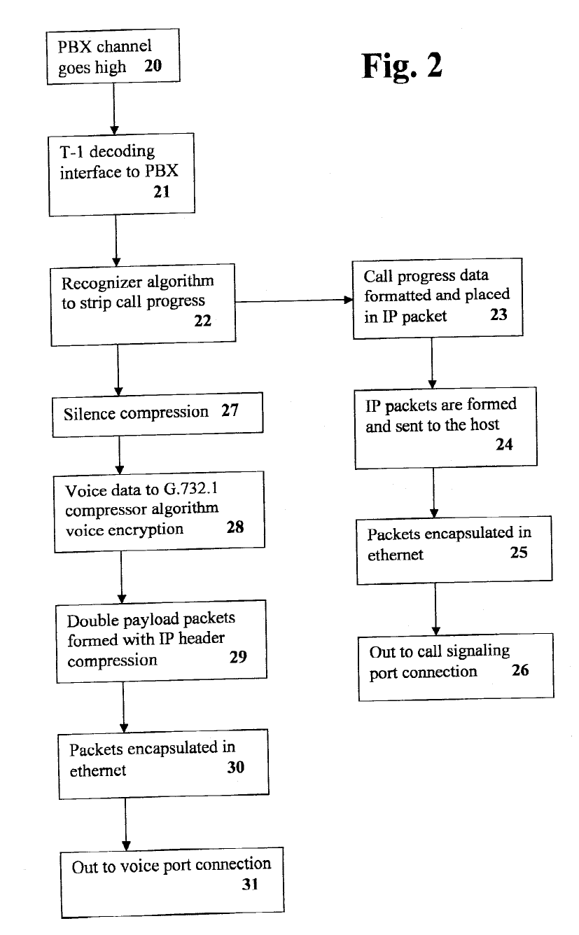

FIG. 2 depicts the data flow processes necessary for the placement of a call out from the local PBX. When a channel on the T-1 interface to the PBX “goes high” (20) this indicates an off-hook event. The T-1 interface in the present device interprets the channel high event and starts the processing of the call data (21). The TDM frames for the respective channel are delivered to an algorithm to recognize and remove “Call Progress Tones” (i.e. DTMF) (22). These tones are converted into data, and placed in IP packets (23), the IP packet is formed and sent to host (24), packets are encapsulated in ethernet (25) and sent via a separate logical data connection to the Central Host (26). The remaining “voice” in the TDM frames from the PBX T-1 interface is processed through an algorithm for silence suppression (27) and then an algorithm for compression. The streams are then encrypted using an algorithm with session unique encryption key (28). The resulting stream of compressed, encrypted voice (29) is placed into IP packets every 30 ms with up to 24 calls of payload (30) and sent to the Central Host via a second logical voice connection (31).

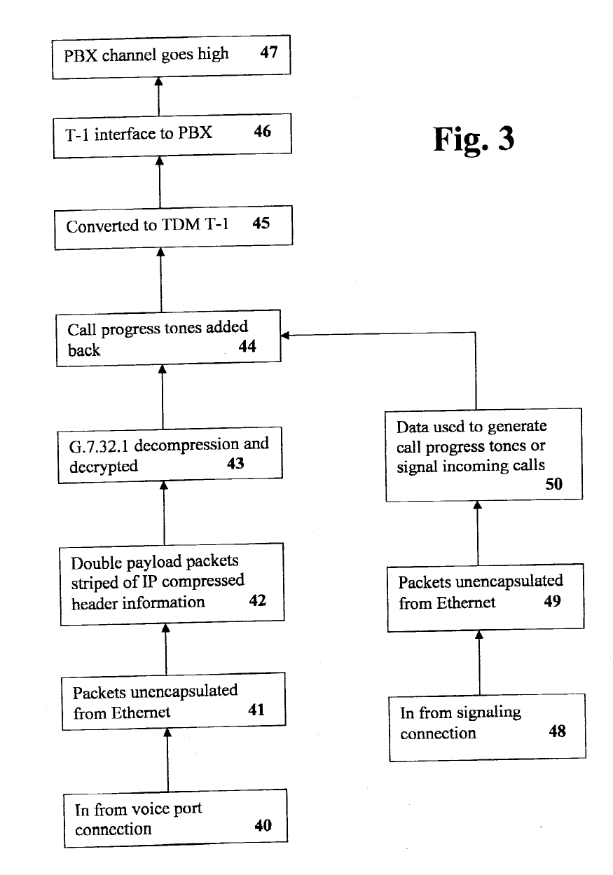

FIG. 3 depicts the data flow processes necessary for the receipt of a call at the present device as it is processed to the local PBX. The device is signaled via the logical signaling connection of the incoming call (40). The voice received on the logical voice port is un-encapsulated from Ethernet (41) and the IP packets are broken down to the double payload of voice (42). The voice payload is processes through a series of algorithms to decrypt and decompress the voice back into a T-1 TDM stream (43). Call progress tones are added back (44) and converted to TDM T-1 (45). The TDM stream is placed through the T-1 interface to the PBX where it is handled as a normal T-1 incoming call (46) and the PBX channel goes high (47). Simultaneously, input from a signaling connection is received (48) and packets are unencapsulated from Ethernet (49). Data are used to generate call progress tones or signal an incoming call (50). Any call progress tones arrive as data via the separate call progress logical connection

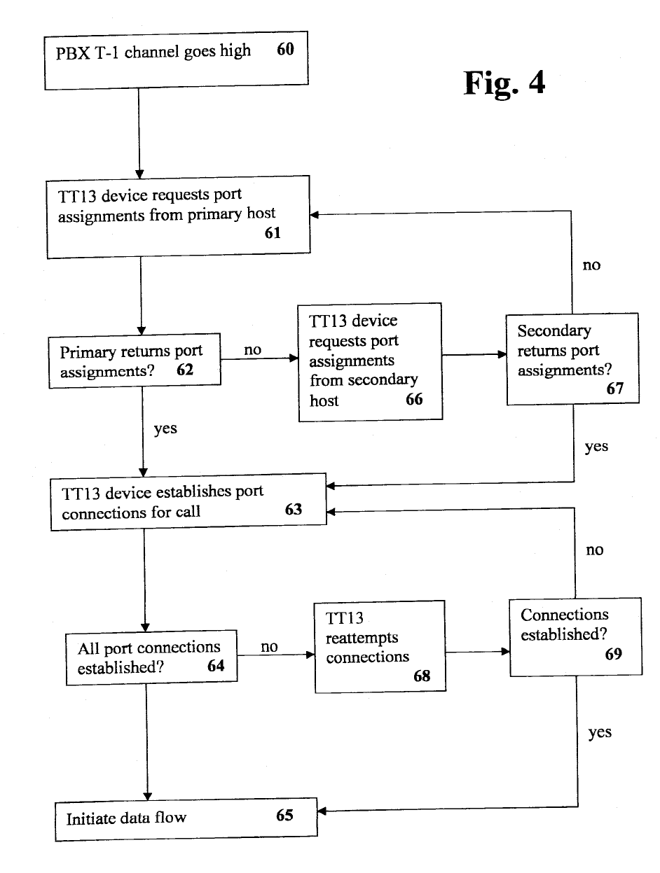

FIG. 4 depicts the logic in the call setup. The PBX T-1 channel goes high (60). The TT13 device requests port assignments from the primary host (61). The system questions whether the primary returns port assignments (62). If yes, the TT13 device establishes port connections for a call (63). The system then questions whether all port connections are established (64). If yes, the system initiates data flow (65). If the primary has not returned port assignments, the TT13 device requests port assignments from the secondary host (66). The system then questions whether the secondary host has returned port assignments (67). If yes, the TT13 device establishes port connections for a call (63). If no, TT13 device requests port assignments from the primary host (61). This iteration may be abandoned after 3 cycles. If all port connections are not established, the TT13 reattempts connections (68). The system then questions whether the connections are established (69). If yes, the system initiates data flow (65). If no, the TT13 device establishes port connections for a call (63). This iteration may be abandoned after 3 cycles.

The system and method of the present invention never receives (or processes) analog speech and uses twenty four memory elements on one frame buffer. The method of encryption uses a different key on each phone call based on a changing cipher. All calls coming into the system are transmitted VoIP, independent of the dialed number. The system does not set up a direct connection between endpoints. All calls are routed through a redundant data center and then out to endpoints. Tunneling or PPP connections are not used. Routing through the redundant data centers allows the monitoring of the quality of the call (packet loss, jitter, echo) and making adjustments during the call to maintain quality. The system routes calls automatically and requires no response or input other than dialing the regular phone number.

### Packet Formation

### TAP—Targeted Access Protocol

TAP uses both UDP and TCP to transceive audio and signaling for phone data. The UDP connection is the ‘voice socket’ and the TCP connection is ‘control socket’. There is one connection of each type to each TAD box regardless the number of active conversations.

### TAP Transports Three Types of Information:

1. Call setup and teardown (switch hook status, DTMF signaling, and port negotiation) carried over the control socket.
2. Real-time voice data (compressed voice data) carried over the voice socket.
3. Diagnostic information (packet and timing statistics) carried over the control socket.

### Control Socket Format

### <STX><TRANSPARENT_MESSAGE_BODY><ETX>

Since TCP is stream-oriented, messages must be delineated with some sort of framing. TAP uses STX (0x02) to mark the beginning of a packet and ETX (0x03) to mark the end of a packet. An escape character, DLE (0x10), precedes any STX, ETX, or DLE character within the message body so that arbitrary binary data may occur in the body without false framing.

### Control Messages

All currently-implemented TAP TCP messages are identified by a single character immediately following the STX. TRANSPARENT_MESSAGE_BODY and can be one of the following (each format is preceded by TAD: or SERVER:, indicating which side can generate this message):

### Hello

### TAD: <‘H’><TAD_ID>

This packet is the first one sent to the server by TAD when TAD opens the TCP port. A 6-character unique ID code for the TAD box follows the ‘H’ and is used to authenticate the TAD. The 6 character ID is configured into each TAD via its configuration program, accessible from the serial port or telnet. If the TAD passes authentication (the 6-digit ID code is valid), then the server responds with a Hello packet.

### SERVER: <‘H’><SERVER_IP_ADDRESS>‘:’<VOICE_PORT>

This packet is sent by the server in response to a TAD Hello packet, and gives TAD a server IP address and UDP port number to use for voice data.

<SERVER_IP_ADDRESS> is the ASCII representation of the server address, i.e. ‘10.20.30.40’. <VOICE_PORT> is the ASCII representation of the port number.

### KEY

### SERVER: <‘K’><ENCRYPTION_KEY>

The server sends this message to set an encryption key to be used for the compressed voice data. ENCRYPTION_KEY is an 8-digit ASCII hexadecimal value which represents the 32-bit encryption key.

### OFF_HOOK

### TAD: <‘O’><PHONE_ID>

Notifies the server that signaling has gone active for an incoming T1 channel. PHONE_ID is a 2-digit, 0-relative ASCII channel ID which can range from ‘00’ to ‘23’.

### SERVER: <‘O’><PHONE_ID>

Notifies TAD that the server wants to place a call to one of the ports on the T1 channel. PHONE_ID can be ‘00’ to ‘23’ if a specific channel is desired, or ‘99’ if TAD should pick the port. Any OFF_HOOK message from the server will be responded to by TAD (see ‘STATUS’ message).

### STATUS

### TAD:<‘S’><TYPE><STATUS_DATA>

This message is used to send a variety of status messages to the server. <TYPE> is a single character which specifies the format of <STATUS_DATA>. Its defined values are:
‘O’: Reply to OFF_HOOK. <STATUS_DATA> is a 14-character field formatted as follows:
CCOOOOOORRRRRR
CC is a two-digit channel field which tells the server which channel was selected by an OFF_HOOK command. It is normally ‘00’ to ‘23’. If no channel was available for selection, this field will be ‘99’. OOOOOO is a 6-character ASCII hexadecimal bit mask of all channels which are currently off hook. Bit 0 represents channel 0. For example, if channels 23, 8, 3, and 1 were off hook, this field would contain ‘80010A’. RRRRRR is a 6-character ASCII hexadecimal bit mask of all channels which are currently ringing
‘T’: T1 status change. <STATUS_DATA> is a single ASCII digit which specifies the health of the T1 line. Its possible values are:
   ‘0’: T1 OK
   ‘1’: T1 Loss of Sync (RED alarm)
Anything but a ‘0’ may indicate a service-affecting failure mode. This message is sent autonomously whenever the T1 status changes.
‘A’: Keep-alive message. <STATUS_DATA> is ‘T’ for a TAD-initiated keep-alive message, and ‘S’ for a server-initiated keep-alive message. This message is OK for either TAD or the server to send at any time. A time-out will be implemented in TAD which causes it to disconnect from a server after some number of seconds without a keep-alive or any other message being received over the UDP channel. When there are no active channels (all phones on-hook), TAD will send a keep-alive message at least once every 10 seconds. The server must do the same.

### ON_HOOK

### TAD: <‘N’><PHONE_ID>

Notifies the server that signaling has gone inactive for an incoming T1 channel. PHONE_ID is a 2-digit, O-relative ASCII channel ID which can range from ‘00’ to ‘23’.

### FLASH_HOOK

### TAD: <‘F’><PHONE_ID>

Notifies the server that signaling has pulsed for an incoming T1 channel. PHONE_ID is a 2-digit, 0-relative ASCII channel ID which can range from ‘00’ to ‘23’.

### DTMF

### TAD: <‘D’><PHONE_ID><ON_OFF><DTMF>

Notifies the server of a change in DTMF signaling state. PHONE_ID is a 2-digit, 0-relative ASCII channel ID which can range from ‘00’ to ‘23’. ON_OFF is a single ASCII character, ‘0’ means ‘tone off’, and ‘1’ means ‘tone on’. DTMF is the ASCII code for the digit being pressed and will be in the set [‘0’ . . . ‘9’, ‘*’, ‘\’].

### SERVER: <‘D’><PHONE_ID><ON_OFF><DTMF>

Same as the above, except used by server to play or stop a DTMF tone on a channel.

### Addressing:

The TAD endpoint must be configured with the address of a TAD server. The TAD endpoint opens a specific TCP port to the server. The server authenticates the TAD endpoint and offers it a UDP port over which the real-time voice data will be sent. Once the server has offered a UDP port to the TAD endpoint, the TAD endpoint will send its real-time audio stream to that UDP port whenever there is at least one active connection.

The UDP port to which TAD will listen for incoming packets is fixed at 3400 decimal.

### Keep-Alive Packets:

When there are no active connections, a keep-alive packet will be sent by the TAD endpoint over the UDP connection every few seconds. The server is expected to reply to this message over the UDP connection. When this packet is missing for more than some time-out period, the server closes both the UDP and TCP connections. When the server fails to respond for some time-out period, the TAD endpoint closes both connections and tries to re-connect to the TCP socket on the server every few seconds.

### UDP Packet Format

UDP is used to transceive the compressed audio. Up to 24 channels of compressed audio can be transferred in a single UDP packet. Each frame of 723.1 compressed audio contains 24 bytes which represent 30 mS (240 samples at 8 KHz) of speech 24 channels of 24 bytes =576 bytes of compressed data. The MTU of UDP is 1,500 bytes. Two frames of 723.1 would contain 1,152 bytes, still easily within the MTU. Each UDP packet contains a header, followed by payload. The UDP packet format is:

### <MAGIC><SEQ><CHANNELMASK>

### <PAYLOAD1>[‘F’<CHANNELMASK><PAYLOAD2>]

MAGIC is a 4-byte magic number which identifies a valid TAP packet. This is an ASCII string which will be ‘TADS’ for packets with single framing (24-bytes per channel) or ‘TADD’ for packets with dual framing (48-bytes per channel.)
SEQ is a one-byte unsigned modulo-256 sequence number which is used to detect missing packets. It increments with each packet. It is reset to 0 when the server assigns the UDP port.
CHANNELMASK is a three byte, 24 bit mask of which channels are present in the payload. All phone and bit numbers are zero-relative.

Bit 7 of byte 5 is phone 23. Bit 7 of byte 6 is phone 15. Bit 7 of byte 7 is phone 7.

1=audio for this channel is present in this packet

0=audio for this channel is not present in this packet

PAYLOAD1/2 is the concatenation of the 723.1 compressed data for each of the audio channels included in the packet. Lower-numbered channels come first in the payload. The portion within square brackets is only present in the case of a double frame (configured in the TAD box and indicated by the magic number in the packet header.)

### Encryption

The UDP voice data can optionally be encrypted. The encryption will be a simple XOR with a key which is provided by the server over the control stream. The KEY message is used by the server to supply this value. The key is a 32-bit quantity which will be used to XOR the 723.1 data. Each channel's 723.1 data is 20 bytes in length. The XOR may be performed as follows:

packet[0] XORs with KEY & 0xff
packet[1] XORs with (KEY >>8) & 0xff
packet[2] XORs with (KEY >>16) & 0xff
packet[3] XORs with (KEY >>24) & 0xff
packet[4] XORs with KEY & 0xff
. . . (repeat for entire packet data)

These XORs may be performed 4 at a time by XOR'ing the key with 4 bytes of packet at a time. Only the actual 723.1 packet data will be XOR'd with the key.

The same XOR operation with the same key may decrypt the packet data. The key may be changed by the server at any time, but there may be a short time lag in which the old key is used. This key is changed for each call.

### Criteria for Included Channels

To be included in a UDP packet, a channel must be active (off-hook) and non-silent. When a channel on the PBX T1 line goes active, an off-hook message is sent to the server by TAD. From this point on, the active channel will be represented in each frame of real-time audio in one of the following ways:
1. Active audio
In this case, the active channel will be represented by a ‘1’ in the <CHANNELMASK> field. The compressed audio will be present in the payload.
2. DTMF active
In this case, the active channel will be represented by a ‘0’ in the <CHANNELMASK> field. There will be no compressed audio present for this channel. The control socket is used by TAD to notify the server of DTMF tone detection. If the server is generating an audio stream from a channel, it uses local DSP resource to re-generate the DTMF tone.
3. Silent audio
In this case, the active channel will be represented by a ‘0’ in the <CHANNELMASK> field. There will be no compressed audio present for this channel. When the server knows a channel is off-hook, the channel does not have DTMF present, and the channel has a ‘0’ in <CHANNELMASK>, it may infer that silence has been detected and send a silence frame to the local 723.1 decoder.
   Using this scheme, data volume is kept to an absolute minimum.

### Quality Measurement

The three measures of IP connection quality with which TAP is concerned are:

1. Transit time

### 2. Jitter

3. Packet delivery

Transit time is simply the amount of time it takes for a packet to travel from TAD to the server or back. Jitter is the difference between the arrival time of a packet and its expected arrival time. Packet delivery is a statistical measure of how often packets get dropped.

TAP can provide for transit time measurement using wallclock time from an NTP server. Jitter can be measured at TAD with a high-resolution timer which accurately determines packet arrival time. Packet delivery can be measured by tracking lost sequence numbers. All of these statistics can be available over the control connection.

The foregoing description has been limited to specific embodiments of this invention. It will be apparent, however, that variations and modifications may be made by those skilled in the art to the disclosed embodiments of the invention, with the attainment of some of all of its advantages and without departing from the spirit and scope of the present invention. For example, both wire and wireless forms of communication may be used. Any suitable types of computers and phones may be used.

It will be understood that various changes in the details, materials, and arrangements of the parts which have been described and illustrated above in order to explain the nature of this invention may be made by those skilled in the art without departing from the principle and scope of the invention as recited in the following claims.

1. A communication system implementing voice over an Internet Protocol comprising:
a) an IP network,
b) a TDM source stream;
c) decoder to decode said TDM source stream;
d) a converter to convert and strip call progress tones into a separate data form;
e) an encrypter/decrypter to encrypt voice packets;
f) a compressor to compress remaining voice; and
g) a packetizer to form packets in output that is in an IP compatible format suitable for transfer over said IP Network.

2. The communication system of claim 1 further comprising means for silence suppression wherein said silence suppression is performed prior to voice stream compression.

3. The communication system of claim 1 further comprising a receiving section acquiring said packets from said packetizer and transferring said packets across said IP network.

4. The communication system of claim 1 further comprising out of band signaling of a maximum of seven commands and a command length less than ten bytes.

5. The communication system of claim 1 wherein said TDM source stream is an E1/T1/PRI TDM stream.

6. The communication system of claim 1 wherein said packetizer packets cells into UDP over IP frames.

7. The communication system of claim 1 wherein said TDM source stream originates at either a receiving station or a sending station.

8. The communication system of claim 3 wherein said receiving section further comprises:
a) a cell extractor to strip the cells from a UDP payload;
b) a reassembler to restructure stripped cells into their correct sequence;
c) a decompressor to decompress compressed voice to PCM;
d) a tone generator for the reinsertion of call progress tones into a decompressed voice; and
e) a framer and encoder.

9. The communication system of claim 3 wherein output from said framer and encoder is transmitted as PCM voice.

10. A communication system implementing voice over an Internet Protocol comprising:
a) an IP network;
b) a TDM source stream;
c) decoder to decode said TDM source stream;
d) a converter to convert and strip call progress tones into a separate data form;
e) an encrypter/decrypter to encrypt voice packets;
f) a compressor to compress remaining voice;
g) a packetizer to form packets in output that is in an IP compatible format suitable for transfer over said IP Network;
h) means for silence suppression wherein said silence suppression is performed prior to voice stream compression;
i) a receiving section acquiring said packets from said packetizer and transferring said packets across said IP network; and
j) out of band signaling of a maximum of seven commands and a command length less than ten bytes

11. The communication system of claim 10 wherein said TDM source stream is a E1/T1/PRI TDM stream.

12. The communication system of claim 10 wherein said packetizer packets cells into UDP over IP frames.

13. The communication system of claim 10 wherein said TDM source stream originates at either a receiving station or a sending station.

14. The communication system of claim 10 wherein said receiving section further comprises:
a) a cell extractor to strip the cells from a UDP payload;
b) a reassembler to restructure stripped cells into their correct sequence;
c) a decompressor to decompress compressed voice to PCM;
d) a tone generator for the reinsertion of call progress tones into a decompressed voice; and
e) a framer and encoder, wherein output from said framer and encoder is transmitted as PCM voice.

15. A communication system implementing voice over an Internet Protocol comprising:
a) an IP network;
b) a TDM source stream;
c) decoder to decode said TDM source stream;
d) a converter to convert and strip call progress tones into a separate data form;
e) an encrypter/decrypter to encrypt voice packets;
f) a compressor to compress remaining voice;
g) a packetizer to form packets in output that is in an IP compatible format suitable for transfer over said IP Network;
h) means for silence suppression wherein said silence suppression is performed prior to voice stream compression;
i) a receiving section acquiring said packets from said packetizer and transferring said packets across said IP network;
j) out of band signaling of a maximum of seven commands and a command length less than ten bytes;
k) said TDM source stream being a E1/T1/PRI TDM stream;
l) said packetizer packets cells into UDP over IP frames; and
m) said TDM source stream originates at either a receiving station or a sending station.

16. The communication system of claim 15 wherein said receiving section further comprises:
a) a cell extractor to strip the cells from a UDP payload;
b) a reassembler to restructure stripped cells into their correct sequence;
c) a decompressor to decompress compressed voice to PCM;
d) a tone generator for the reinsertion of call progress tones into a decompressed voice; and
e) a framer and encoder, wherein output from said framer and encoder is transmitted as PCM voice.

17. A communication system implementing voice over an Internet Protocol comprising:
a) an IP network;
b) a TDM source stream;
c) decoder to decode said TDM source stream;
d) a converter to convert and strip call progress tones into a separate data form;
e) an encrypter/decrypter to encrypt voice packets;
f) a compressor to compress remaining voice;
g) a packetizer to form packets in output that is in an IP compatible format suitable for transfer over said IP Network;
h) means for silence suppression wherein said silence suppression is performed prior to voice stream compression;
i) a receiving section acquiring said packets from said packetizer and transferring said packets across said IP network;
j) out of band signaling of a maximum of seven commands and a command length less than ten bytes;
k) said TDM source stream being a E1/T1/PRI TDM stream;
l) said packetizer packets cells into UDP over IP frames;
m) said TDM source stream originates at either a receiving station or a sending station; and
n) said receiving section having a cell extractor to strip the cells from a UDP payload; a reassembler to restructure stripped cells into their correct sequence; a decompressor to decompress compressed voice to PCM; a tone generator for the reinsertion of call progress tones into a decompressed voice; and a framer and encoder, wherein output from said framer and encoder is transmitted as PCM voice.
